(19) United States
(12) Patent Application Publication
(10) Pub. No.: US 2009/0227327 A1
(43) Pub. Date: Sep. 10, 2009

(54) Slot Machine

(75) Inventor: Kazumasa Yoshizawa, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: Aruze Corp., Tokyo (JP)

(21) Appl. No.: 12/137,594

(22) Filed: Jun. 12, 2008

Related U.S. Application Data
(60) Provisional application No. 61/034,638, filed on Mar. 7, 2008.

(51) Int. Cl. A63F 13/00

(52) U.S. Cl. 463/20

(57) ABSTRACT

A slot machine includes a display device having a controller for controlling the display device, the input device, the first memory, and the second memory. The controller is programmed to add the bonus point to a cumulative value of the first memory during the basic game; add the credit to a cumulative value of the second memory during the basic game; execute a free game, in a case where a predetermined condition is met during the basic game; execute a bonus game by a number of times equal to the cumulative value of the bonus points stored in the first memory, during a predetermined period from before start to after termination of the free game; and award a prize determined based on the cumulative value of the second memory, in a case where a second symbol displayed in the symbol display region met a predetermined condition during the bonus game.

### CROSS-REFERENCE TO RELATED APPLICATIONS

This application claims priority of U.S. Provisional Application No. 61/034,638 filed on Mar. 7, 2008. The contents of this application are incorporated herein by reference in their entirety.

### BACKGROUND OF THE INVENTION

1. Field of the Invention

The present invention relates to a slot machine.

2. Description of the Related Art

Slot machines known as a type of gaming machines are constituted so as to: start games by players inserting coins or the like into the gaming machine; rearrange columns of symbols in predetermined region of the gaming machine; and award a prize based on a combination of rearranged symbols.

In addition, the above slot machines are generally constituted to judge whether or not a winning combination allowed to award a prize is established, based on whether or not a predetermined number of symbols of the same type (for example, “CHERRY” or “7”) are arranged along a preset payline. In the conventional slot machine, in a case where a predetermined number or more of symbols of the same type are arranged, it has been a common routine to award a prize based on the number of the aforementioned arranged symbols, regardless of the payout line.

Further, many of the conventional slot machines have been known which alternately conduct two types of games, i.e., a basic game and a free game. The basic game is executed upon consumption of inserted gaming values, namely, a credit. On the other hand, the free game is executed without consuming a credit.

It is a common routine to perform control to switch the basic game to the free game when the predetermined condition is met. The condition includes a case in which, for example, a combination of predetermined symbols is rearranged during the basic game. The free game is switched to the basic game when the predetermined condition is met. The condition includes a case in which, for example, the free games are executed by a predetermined number of times or which a combination of predetermined symbols is rearranged and a prize is awarded.

In the conventional slot machines, it has been a common routine to change arrangement of symbols at the time of switching to the free game so as to raise players' feeling of expectation that a combination of predetermined symbols would be rearranged. For example, U.S. Pat. No. 6,394,902-B1 describes a video-reel slot machine in which a total of fifteen symbols are displayed on a matrix display in three rows and five columns. This slot machine decreases types of symbols arranged on reels from eight to five types at the time of switching to the free game. In this manner, a control is performed to raise the possibility of establishing a combination allowed to award a prize during the free game.

Further, a bonus prize is set that is awarded in a case where a combination of special symbols is rearranged, in which a big prize, namely, so-called jackpot is awarded, thereby enhancing entertainability of the slot machine.

The possibility of winning this jackpot, however, is kept low. Therefore, there is an aspect that players consider the jackpot as no more than an accidentally-winnable prize.

The present invention has been made in view of the above-described circumstance. It is an object of the present invention to provide a novel slot machine and a controlling method thereof for providing higher entertainability by performing game control that enables players to raise expectations for establishment of the jackpot.

### SUMMARY OF THE INVENTION

A first aspect of the present invention is a slot machine including: a display device having a symbol display region for displaying plural types of symbols in a matrix form; an input device for accepting BET; a first memory for cumulatively storing a bonus point which is awarded, in a case where a predetermined number or more of first symbols contained in the plural types of symbols are rearranged in the symbol display region; a second memory for cumulatively storing at least one part of a credit which is bet through the input device; and a controller for controlling the display device, the input device, the first memory, and the second memory. The controller is programmed to (a) execute a basic game; (b) rearrange the plural types of symbols in the symbol display region during the basic game; (c) add the bonus point to a cumulative value of the first memory during the basic game; (d) add the credit to a cumulative value of the second memory during the basic game; (e) execute a free game, in a case where a predetermined condition is met during the basic game; (f) execute a bonus game by a number of times equal to the cumulative value of the bonus points stored in the first memory, during a predetermined period from before start to after termination of the free game; and (g) award a prize determined based on the cumulative value of the second memory, in a case where a second symbol displayed in the symbol display region met a predetermined condition during the bonus game.

According to the first aspect of the present invention, when a predetermined number or more of the first symbols are rearranged during the basic game, the bonus point as a right to execute the bonus game is awarded, and the bonus game is executed by the equal number of times to a cumulative value of bonus points. In a case where the second symbol is rearranged on a symbol display screen under a predetermined condition, a so-called jackpot is awarded. If the bonus point is won in the basic game, players are conscious that the bonus game, which possibly awards the jackpot, may be executed later, thereby being allowed to play the game with expectations. Entertainability of the slot machine is enhanced by adding the above bonus game.

A second aspect of the present invention is a slot machine constituted as set fourth below. In the first aspect, the controller, in the itemized (g), determines plural types of prizes based on the cumulative value of the second memory and, awards the prize according to an outcome of the bonus game.

A third aspect of the present invention is a slot machine constituted as set forth below. In the first aspect, the controller, in the itemized (f), executes the bonus game that the plural types of symbols containing the second symbol are rearranged.

According to the above aspects, when the second symbol indicative of a so-called jackpot is rearranged in the symbol display region under a predetermined condition, the jackpot is awarded. The second symbol may change depending on a grade of the awarded prize. In a case where the payout increases in the order of MIN, MEJOR, and MEGA, for example, the symbols may be prepared correspondingly to those prizes, respectively.

A fourth aspect of the present invention is a slot machine constituted as set forth below. In the first aspect, the controller, in the itemized (f), terminates the bonus game without execution of remaining bonus games during the plural bonus games, in a case where the second symbol is rearranged before a last bonus game.

Even where the bonus game is continued after the second symbol is rearranged under a predetermined condition and the jackpot is awarded, the jackpot is not awarded again, so that it is rational for even the player to complete the bonus game.

A fifth aspect of the present invention is a slot machine constituted as set forth below. In the first aspect, the controller, in the itemized (f), rearranges a plurality of cards on which the symbols containing the second symbol are drawn, in the symbol display region in a state where the symbols are invisible, and executes the bonus game that the equal number of cards to the cumulative value of the second memory are switched in a state where the symbols are visible.

During the bonus game, the slot machine with the above structures switches a screen from a symbol display screen to a card display screen in which the plurality of cards are displayed. It is preferable that the displayed cards have common patterns such as those on back surfaces of trump or tarot cards so that the respective cards are not visually distinguishable by the players. The player selects and designates the card while the processor changes the pattern of the designated card in a manner to display the symbol. In a case where the pattern after changed corresponds to the pattern indicative of a so-called jackpot, which meets a predetermined condition, the jackpot is awarded. The pattern of the second symbol may be distinguished depending on a grade of the prize to be awarded. In a case where the payout increases in the order of MIN, MEJOR, and MEGA, for example, the patterns may be prepared correspondingly to those prizes, respectively.

A sixth aspect of the present invention is a slot machine constituted as set forth below. In the first aspect, the slot machine further includes an input device for accepting entry of side BET. The controller, in the itemized (b), rearranges the first symbol in the symbol display region upon accepting the entry of the side BET from the input device.

According to the above aspect, the first symbol is rearranged only where a credit is entered upon the side BET. Therefore, the player who does not place the side BET cannot win the bonus point because the first symbol is not rearranged during the basic game, thereby not being able to execute the bonus game. Under a control as described above, fairness between the player who places the side BET and the player who does not can be maintained in a case of setting the game that the jackpot is financed by the credit from the side BET.

### BRIEF DESCRIPTION OF THE DRAWINGS

FIG. 1 is a view showing an exemplary symbol matrix during a basic game according to a first embodiment;

FIG. 2 is a perspective view schematically showing an appearance of a slot machine according to the first embodiment;

FIG. 3 is a block diagram depicting an internal construction of the slot machine shown in FIG. 2.

FIG. 4A is a view showing an exemplary symbol matrix displayed during the basic game according to the first embodiment;

FIG. 4B is a view showing an exemplary symbol matrix displayed during the basic game according to the first embodiment;

FIG. 5A is a view showing an exemplary image displayed during the free game in the slot machine shown in FIG. 2;

FIG. 5B is a view showing an exemplary symbol matrix during the free game according to the first embodiment;

FIG. 6A is a view showing an exemplary image displayed during the free game in the slot machine shown in FIG. 2;

FIG. 6B is a view showing an exemplary symbol matrix during the free game according to the first embodiment;

FIG. 7 is a flowchart showing a subroutine of a main process according to the first embodiment;

FIG. 8 is a flowchart showing a subroutine of a game execution process according to the first embodiment;

FIG. 9 is a flowchart showing a subroutine of a basic game symbol rearrangement process according to the first embodiment;

FIG. 10 is a flowchart showing a subroutine of a bonus game symbol rearrangement process according to the first embodiment;

FIG. 11A is a view showing an exemplary card display screen during a bonus game according to the first embodiment;

FIG. 11B is a view showing an exemplary card display screen during the bonus game according to the first embodiment;

FIG. 12 is a flowchart showing a subroutine of the bonus game execution process according to the first embodiment;

FIG. 13 is a perspective view schematically showing an appearance of a slot machine according to a second embodiment;

FIG. 14A is a view showing an exemplary symbol matrix during a basic game according to the second embodiment; and

FIG. 14B is a view showing an exemplary symbol matrix during the basic game according to the second embodiment.

### DESCRIPTION OF THE PREFERRED EMBODIMENTS

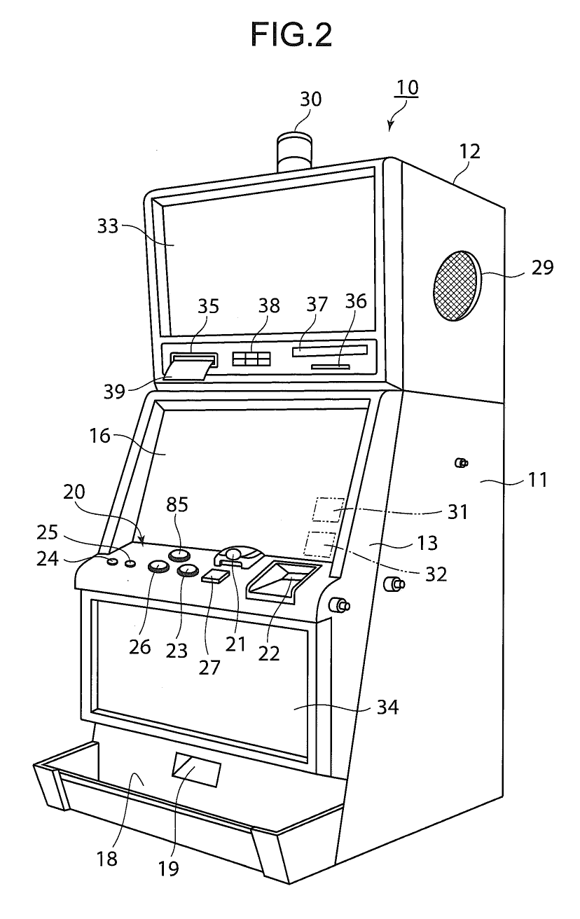

First, a slot machine 10 (see FIG. 2) according to a first embodiment will be described with referring to the drawings. The slot machine according to the first embodiment is a so-called video slot machine, which has an image display panel such as a liquid crystal display and executes a game by displaying images of various symbols on the image display panel. The slot machine 10 according to the present invention executes two gaming modes alternately. The two gaming modes include a basic game and a free game. The basic game is executed upon consumption of inserted gaming values bet by players, namely, a credit. The free game is executed without consuming the credit. When a right to execute a bonus game is stored at the time of shifting a game from the basic game to the free game when the predetermined condition is met, a chance for winning the jackpot is given upon execution of the bonus game. The slot machine 10 is of a stand-alone type, which is not connected to a network, the present invention is also applicable to a networked slot machine.

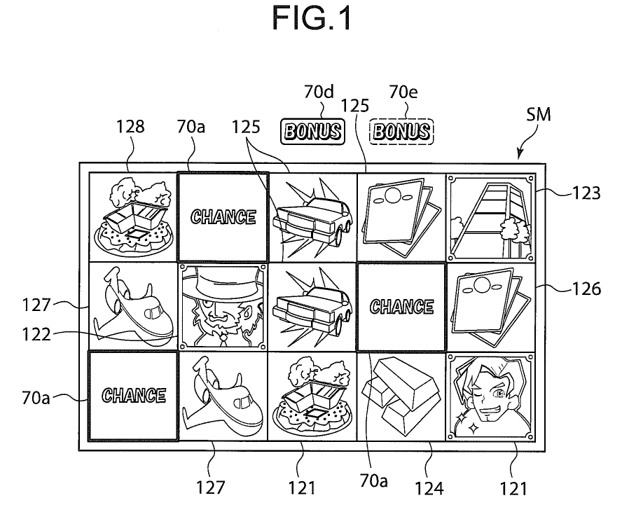

FIG. 1 is a view showing an exemplary display of a symbol matrix during a basic game according to the first embodiment. The symbol matrix 28 is displayed on a lower image display panel 16 described later, included in the slot machine 10. The symbol matrix 28 is made up of cells in three rows and five columns, in which the symbols can be rearranged. In the cells in FIG. 1, symbols “main character 121”, “sub character 122”, “office building 123”, “gold bullion 124”, “car 125”, “stock certificate 126”, “jet 127”, “villa 128”, and “CHANCE 70a” are rearranged.

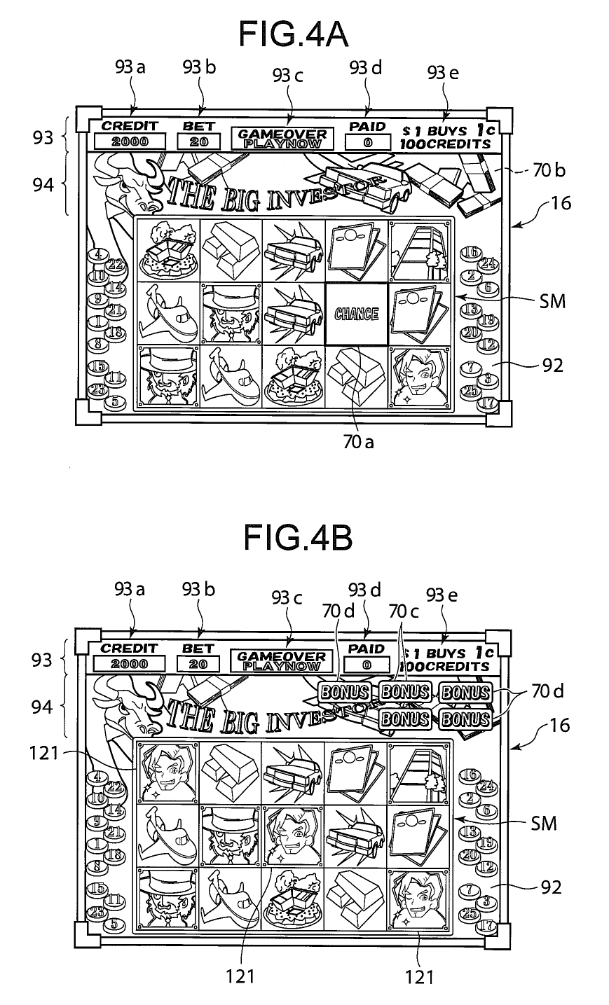

As shown in FIG. 1, in a case where three symbols “CHANCE 70a” are rearranged in the symbol matrix during the basic game, an icon “BONUS 70e” is displayed in a blinking state in an effect image display region 94 (see FIGS. 4A and 4B) right above the symbol matrix. Next to the icon “BONUS 70e”, an icon “BONUS 70d” is displayed, which indicates that more than three symbols “CHANCE 70a” had been rearranged prior to a previous game. Specifically, every time when three or more symbols “CHANCE 70a” are rearranged, the icon “BONUS 70e” is displayed cumulatively in the display region 94. The number of icons “BONUS 70e” displayed in the display region 94 is a bonus point, which indicates acquisition of a right to execute the bonus game by the equal number of times to the number of icons 70e.

FIG. 2 is a view schematically depicting an appearance of an appearance of the slot machine according to the first embodiment. The gaming media used in the slot machine 10 include coins, bills, or electronic value information equivalent thereto. In the present invention, however, the gaming media are not limitative thereto in particular, and can include medals, tokens, electric money, and tickets, for example. The above tickets are not limitative in particular, and can include barcode-attached tickets or the like, as described later, for example.

The slot machine 10 is provided with a cabinet 11, a top box 12 installed on an upper side of the cabinet 11, and a main door 13 provided on a front surface of the cabinet 11.

The lower image display panel 16 serving as a display device is provided in front of the main door 13. The lower image display panel 16 is provided with a liquid crystal panel, which displays the cells of the symbol matrix 28 in three rows and five columns. A single symbol is arranged in each of the cells of the symbol matrix 28, and the maximum of fifteen symbols can be displayed.

A credit amount display section 31 of the lower image display panel 16 displays a credit corresponding to the number of inserted coins by way of an image. A payout amount display unit 32 displays by way of an image, a combination of rearranged symbols or the number of coins to be paid if the predetermined number of symbols are rearranged.

Provided on the lower side of the lower image display panel 16 at a center of the main door 13 is a control panel 20 on which a plurality of buttons 23 to 27 and 85 through which command regarding the process of the game is entered, a coin receiving slot 21 for receiving coins into the cabinet 11, and bill validator 22 are disposed.

On the control panel 20, a start button 23, a change button 24, a cashout button 25, a 1-BET button 26, a MAX-BET button 27, and a side-BET button 85 are provided. The start button 23 is intended for entering a command for starting the game. The change button 24 is intended for use in asking an attendant of the gaming facility for change. The cashout button 25 is intended for entering a command for paying out the credited coins to a coin tray 18 through a coin payout exit 19.

The 1-BET button 26 is intended for entering a command for betting a credit corresponding to one coin. The MAX-BET button 27 is intended for entering a command for betting the maximum number (fifteen in this embodiment) of coins that can be bet per game. The side-BET button 85 is used to place a bet on a sub game other than a game in which symbols are rearranged in the symbol matrix 28. In this embodiment, for example, control can be performed to rearrange the symbol “CHANCE 70a” in the symbol matrix 28 when the predetermined credit is bet. A part of credit that has been bet through those input units are cumulatively stored in a memory region provided in a RAM 43 and are used as the reference to determine the amount of payout in a case where the jackpot is won during the bonus game.

The bill validator 22 validates whether or not a bill is legitimate and accepts a legitimate bill into the cabinet 11. The bill validator 22 may be configured so that a barcode-attached ticket 39 described later is readable thereby. Provided on a lower front surface of the main door 13, that is, at a lower part of the control panel 20, is a berry glass 34 on which characters of the slot machine 10 and the like are depicted.

On a front surface of the top box 12, an upper image display panel 33 is provided. The upper image display panel 33 has a liquid crystal panel, which displays images for introducing the game contents or explaining game rules, for example.

Also, on the top box 12, a speaker 29 and a lamp 30 are provided. On a lower side of the upper image display panel 33, a ticket printer 35, a card reader 36, a data display unit 37, and a key pad 38 are provided. The ticket printer 35 prints on the ticket, a barcode having encoded thereon data such as the credit amount, the date and time, and the identification number of the slot machine 10, and outputs the printed ticket as the barcode-attached ticket 39. The player can play the game on another slot machine with the barcode attached ticket 39 by causing this slot machine to read the barcode attached ticket 39. Alternatively, the player can exchange the barcode-attached ticket 39 with the bills or the like at a predetermined place (at a cashier inside a casino, for example) of the gaming facility.

The card reader 36 reads data from and writes data into a smart card. The smart card is to be owned by the player, which stores data for identifying the player or data regarding the log of games executed by the player, for example. The smart chard may store data corresponding to coins, bills, or a credit. As an alternative of a smart card, a magnetic stripe card may be employed. The data display 37 is made up of a fluorescent display and the like, and displays the data read by the card reader or the data input by the player through the key pad 38, for example. The key pad 38 inputs data and commands regarding the ticket issuance or the like.

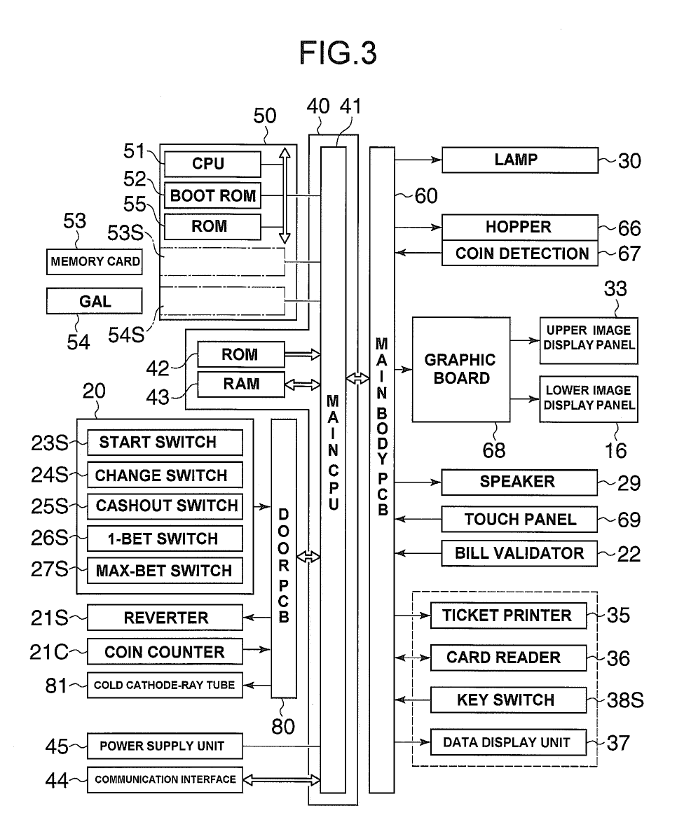

FIG. 3 is a block diagram depicting the internal construction of the slot machine shown in FIG. 2. A gaming board 50 includes: a CPU (Central Processing Unit) 51, a ROM (Read Only Memory) 55 and a boot ROM 52 interconnected by an internal bus; a card slot 53S corresponding to a memory card 53; and an IC socket 54S corresponding to a GAL (Generic Array Logic) 54.

The memory card 53 contains therein a nonvolatile memory and stores game programs. The game programs include a symbol selection program. The aforementioned symbol selection program is intended for determining the symbols to be rearranged in the symbol matrix 28. The aforementioned symbol selection program includes symbol weighing data respectively corresponding to plural types of payout ratios (80%, 84%, and 88%, for example). The symbol weighting data is indicative of the correspondence relationship between the respective symbols and one or more random numeric values which come under a predetermined numerical range (0 to 255). The payout ratio is determined according to the payout-ratio setting data output from the GAL 54. The symbols to be rearranged in the symbol matrix 28 are determined depending upon the symbol weighing data corresponding to this payout ratio. Further, the game programs include table data indicating the correspondence relationship between each of the symbols and a payout.

Also, the card slot 53S is configured to allow the memory card 53 to be inserted thereinto or ejected therefrom, and is connected to a mother board 40 through IDE pass. Accordingly, the memory card 53 can be ejected from the card slot 53S, other game programs and other game system programs can then be written into the memory card 53, and further, the memory card 53 can be inserted into the card slot 53S, thereby allowing the player to change the types and contents of games executed in the slot machine 10. The game program includes data concerning a game progress. Furthermore, the game program includes image data or sound data to be output during the game. The image data include, for example, image data indicative of the symbol matrix 28.

The GAL 54 is a type of a PLD having a fixed OR array structure. The GAL 54 includes plural input ports and plural output ports. Where predetermined data is input to the input port, the GAL 54 outputs data corresponding to the aforementioned data from the output port. The data output from this output port is equivalent to the aforementioned payout-ratio setting data. Further, the IC socket 54S is configured to allow the GAL 54 to be attached thereto and detached therefrom, and is connected to the mother board 40 by a PCI bus. Accordingly, the GAL can be replaced with the replacement GAL 54 to change the payout-ratio setting data.

The CPU 51, the ROM 55, and the boot ROM 52 interconnected by the internal bus are connected to the mother board 40 by the PCI bus. The PCI bus serves to transmit signals between the mother board 40 and the gaming board 50 and supply power from the mother board 40 to the gaming board 50.

The mother board 40 is constructed using a general-purpose mother board commercially available (a printed circuit board on which essential parts of a personal computer are mounted) and includes: a main CPU (Central Processing Unit) 41, a ROM (Read Only Memory) 42; a RAM (Random Access Memory) 43; and a communication interface 44.

The ROM 42 stores thereon a program such as BIOS (Basic Input/Output System) executed by the main CPU 41, and permanent data. When the BIOS is executed by the main CPU 41, processing of initializing predetermined peripheral devices is carried out and processing of capturing game programs and game system programs stored in the memory card 53 through the gaming board 50 is started. In the present invention, the contents of the ROM 42 may be rewritable or not.

The RAM 43 stores data and a program used when the main CPU 41 is activated. The RAM 43 can also store game programs. The RAM 43 further stores data concerning the credit amount, the number of coin-in or coin-out for one game, and the like. In embodiments of the present invention, the RAM 43 stores bonus points cumulatively.

Both a main body PCB (Printed Circuit Board) 60 and a door PCB 80 are connected to the mother board 40 by USB. A power supply unit 45 is also connected to the mother board 40.

Connected to the main body PCB 60 and the door PCB 80 are: equipment and devices which generate input signals to be input to the main CPU 41; and equipment and devices of which operations are controlled by a control signal output from the main CPU 41. The main CPU 41 executes a game program stored in the RAM 43 based on an input signal having been input to the main CPU 41 and performs a predetermined computational process, thereby storing results thereof in the RAM 43 or transmitting a control signal to each of equipment and devices as a control process therefor.

A lamp 30, a hopper 66, a coin detecting section 67, a graphic board 68, a speaker 29, a touch panel 69, the bill validator 22, the ticket printer 35, the card reader 36, a key switch 38S, and the data display unit 37 are connected to the main body PCB 60. The lamp 30 is lit up in a predetermined pattern based on a control signal output from the main CPU 41.

The hopper 66 is installed in the cabinet 11 and pays out a predetermined number of coins from the coin payout exit 19 to the coin tray 18 based on a control signal output from the main CPU 41. The coin detecting section 67 is installed inside the coin payout exit 19 and outputs an input signal to the main CPU 41 upon detecting that a predetermined number of coins have been paid out from the coin payout exit 19.

The graphic board 68 controls, based on a control signal output from the main CPU 41, images to be displayed on the upper image display panel 33 and the lower image display panel 16. The credit amount stored in the RAM 43 is displayed on a credit amount display section 31 (see FIG. 2) of the lower image display panel 16. The number of coins to be paid out is displayed at a payout amount display section 31 (see FIG. 2) of the lower image display panel 16. The graphic board 68 is equipped with a VDP (Video Display Processor) which generates image data based on a control signal output from the main CPU 41 and a video RAM which temporarily stores image data generated by the VDP, and the like. The image data used in generating image data with VDP is contained in the game program read from the memory card 53 and stored in the RAM 43.

The bill validator 22 validates whether or not a bill is legitimate and accepts a legitimate bill into the cabinet 11. Upon accepting a legitimate bill, the bill validator 22 outputs an input signal to the main CPU 41 based on the amount of the bill. The main CPU 41 stores in the RAM 43 the credit amount corresponding to the amount of bills transmitted by the input signal.

Based on a control signal output from the main CPU 41, the ticket printer 35 prints on a ticket a barcode having encoded thereon data such as the credit amount, data and time, and the identification number of the slot machine 10 stored in the RAM 43. Further, this printer outputs the printed ticket as a barcode-attached ticket 39. The card reader 36 transmits to the main CPU 41 the data read from the smart card and writes the read data onto the smart card, based on a control signal from the main CPU 41. The key switch 38S is provided on the keypad 38, and outputs a predetermined input signal to the main CPU 41 when the player operates the key pad 38. The data display 37, based on a control signal output from the main CPU 41, displays the data read by the card reader 36 and the data input by the player through the key pad 38.

The control panel 20, a reverter 21S, a coin counter 21C, and a cold cathode tube 81 are connected to the door PCB 80. The control panel 20 is provided with: a start switch 23S corresponding to the start button 23; a change switch 24S corresponding to the change button 24; a cashout switch 25S corresponding to a cashout button 25; a 1-BET switch 26S corresponding to a 1-BET button 26; a MAX-BET switch 27S corresponding to the MAX-BET button 27; and a side-BET switch 90S corresponding to the side-BET switch 85. When the player operates the buttons 23 to 27 and 85, the corresponding switches 23S to 27S and 90S output input-signals to the main CPU 41, respectively.

The coin counter 21C is provided inside the coin receiving slot 21, and validates whether or not a legitimate coin is inserted into the coin receiving slot 21. Those other than the legitimate coins are discharged from the coin payout exit 19. The coin counter 21C outputs an input signal to the main CPU 41 when a legitimate coin is detected.

The reverter 21S operates based on a control signal output from the main CPU 41 and distributes coins recognized as being legitimate by the coin counter 21C into a cash box (not shown in the drawings) or the hopper 66 which is arranged in the slot machine 10. In other words, when the hopper 66 is filled with coins, legitimate coins are distributed by the reverter 21 S into the cash box. On the other hand, when the hopper 66 is not filled with coins, legitimate coins are distributed into the hopper 66. The cold cathode tube 81 functions as a backlight installed on rear face side of each of the lower image display panel 16 and the upper image display panel 33, and is lit up based on a control signal output from the main CPU 41.

FIGS. 4A to 6B are views each showing an exemplary image displayed on an image display panel of the slot machine 10 shown in FIG. 2 according to the first embodiment. FIGS. 4A and 4B are views each showing an exemplary image displayed during a basic game in the slot machine shown in FIG. 2.

As shown in FIG. 4A, the lower image display panel 16 is made up of a display region 92, an information display section 93, the effect image display section 94, and the like. The symbol matrix 28 is displayed in the display region 92. On both sides of the symbol matrix 28, the icons indicative of the number of coins that have been bet are arranged, and control is performed to blink the icon corresponding to the bet amount. The information display section 93 is arranged upwardly of the display region 92 and is made up of a credit amount display section 93a, a BET amount display section 93b, a character information display section 93c, a PAID amount display section 93d, and a charge display section 93e.

The number of coins currently credited is displayed at the credit amount display section 93a while the number of coins bet on one game is displayed at the BET amount display section 93b. The character information indicative of a current status of the game is displayed at the character information display section 93c. The characters of “PLAYNOW” are displayed during the play of the game, whereas the characters of “GAMEOVER” are displayed during the intervals between the plays of the game. The number of coins that have been paid out in one game is displayed at the PAID amount display section 93d, whereas a conversion value of the credit amount based on a predetermined amount of money is displayed at the charge display section 93e.

The effect image display section 94 displays effect images according to a type of the slot game. In other words, the effect image display section 94 displays different effect images between the basic and free games.

Any of symbols, “main character 121”, “sub character 122”, “office building 123”, “gold bullion 124”, “car 125”, “stock certificate 126”, “jet 127”, “villa 128”, and “CHANCE 70a” are rearranged in the elements of the symbol matrix displayed on the lower image display panel 16. A payout is determined based on the number of these symbols rearranged in the symbol matrix.

FIG. 4A is a view showing a case where the symbols, “main character 121”, “sub character 122”, “office building 123”, “gold bullion 124”, “car 125”, “stock certificate 126”, “jet 127”, “villa 128”, and “CHANCE 70a” are rearranged in the symbol matrix 28 during the basic game. The single symbol “CHANCE 70a” is rearranged, which does not meet the condition to win the bonus point, so that the icon “BONUS 70d” is not displayed in the effect image display section 94. On the other hands, the two symbols “main character 121” are displayed, each of which serves a trigger to switch the basic game to the free game. The condition to start the free game is met when three or more symbols “main character 121” are rearranged. This condition is not met in this case, thereby not starting the free game.

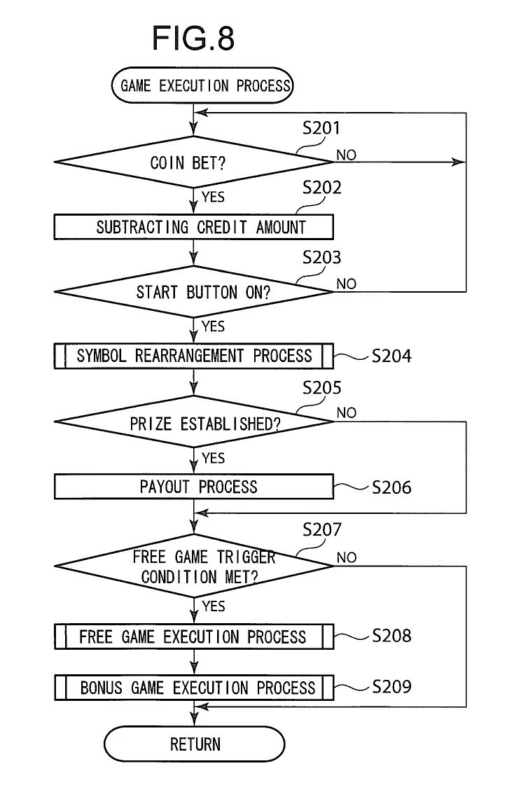

FIG. 4B is a view for showing an exemplary image displayed during the basic game in the symbol matrix 28, relating to determination of start of the free game. In the drawing, the three symbols “main character 121” are displayed in the symbol matrix 28. The condition to start the free game is met in this case, so that a switch to the free game is determined. At this time, timing for executing the bonus game is also determined independently from the free game. Specifically, in a case where the three or more symbols “CHANCE 70a” are rearranged during the basic game, thereby winning the bonus point, control is performed to execute the bonus game at any time before, during, or after the free game. In the first embodiment of the present invention, the bonus game is executed after the free game (see a flowchart of the game execution process in FIG. 8). In the case shown in FIG. 4B, the five icons “BONUS 70d” are displayed in the effect image display section 94, which indicates that the five bonus points are won. Therefore, the bonus game is executed five times.

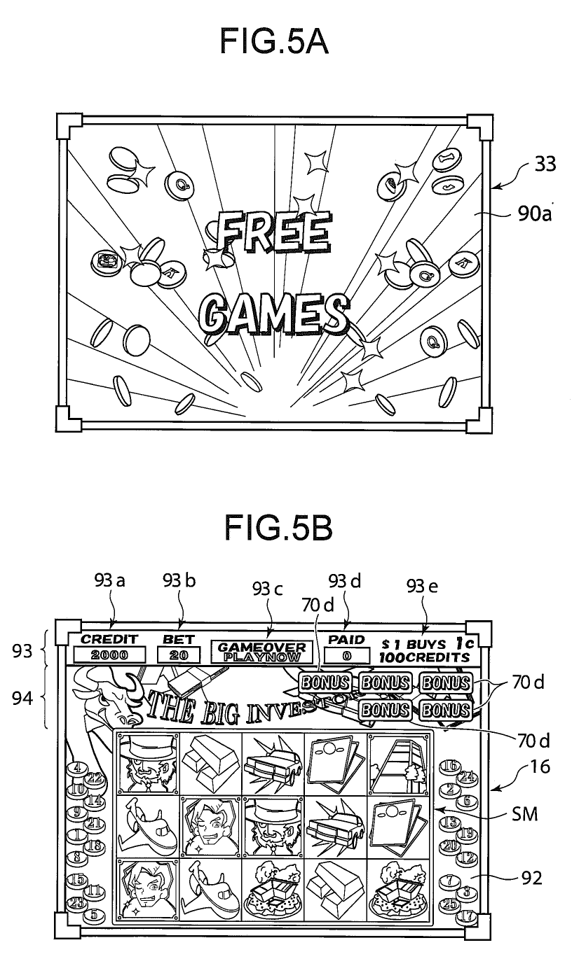

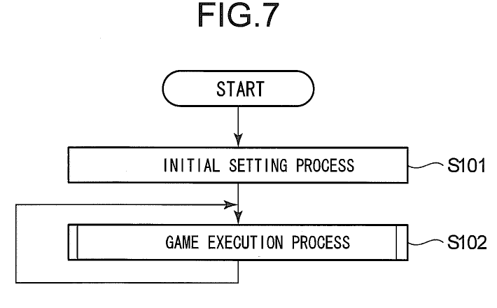

FIGS. 5A, 5B are views each showing an exemplary image displayed on the upper image display panel 33 and the lower image display panel 16 during the free game. In a case where start of the free game is determined, a display image 90b in FIG. 5A is displayed on the upper image display panel 33. On the other hand, the display region 92 of the lower image display panel 16 displays the symbol matrix 28 in FIG. 7B. The five icons “BONUS 70d” are displayed in the effect image display section 94, which indicates acquisition of a right to execute the bonus game five times.

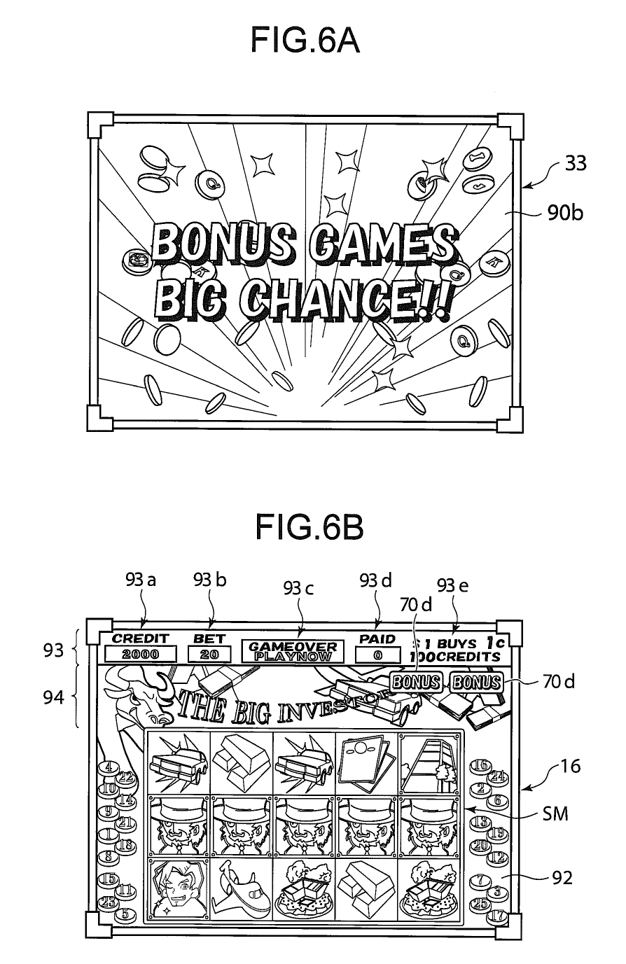

FIGS. 6A, 6B are views each showing an exemplary image displayed on the upper image display panel 33 and the lower image display panel 16 during the bonus game. When the bonus game is started, the display image 90b in FIG. 6A is displayed on the upper image display panel 33, which indicates that the bonus game is in execution. On the other hand, the display region 92 of the lower image display panel 16 displays the symbol matrix 28. FIG. 6B shows an exemplary display of the lower image display panel 16, in which the two icons “BONUS 70d” are displayed in the effect image display section 94, which indicates acquisition of a right to execute the two remaining bonus games. On the other hand, the seven bonus symbols “sub character 122” are displayed in the symbol matrix 28. The symbols more than three, which is the condition for establishment of the bonus, are rearranged, thereby awarding the jackpot. In this case, the remaining two bonus games are not executed and the bonus points are canceled, thereby terminating the bonus game.

Next, a process executed in the slot machine 10 according to the first embodiment, will be described in detail with reference to the drawings. The main CPU 41 controls the progress of a game by reading out of the RAM 43 and executing the game program.

FIG. 7 is a flowchart showing a subroutine of a main process. In the main process, first, when a power switch is turned on (that is, when power is supplied), a mother board 40 and a gaming board 50 are activated respectively, so that the CPU 51 executes an initial setting process (step S101). In this initial setting process, the main CPU 41 executes the BIOS stored in the ROM 42, decompresses, in the RAM 43, compressed data included in the BIOS, executes the BIOS decompressed in the RAM 43, and performs diagnosis and initialization of each of the peripheral devices. The main CPU 41 writes game programs or the like from memory card 53 into the RAM 43, and retrieves data for setting a payout ratio and country-identification information. The main CPU 41 also performs an authentication process for each program during execution of the initial setting process.

Next, the main CPU 41 performs a game execution process described later with reference to FIG. 8 (step S 102). In this game execution process, the main CPU 41 sequentially reads and executes the game programs or the like from the RAM 43. By performing this game execution process, the slot machine 10 according to the first embodiment executes the game. The game execution process is repeatedly performed while power is supplied to the slot machine 10.

FIG. 8 is a flowchart showing a subroutine of the game execution process invoked and performed at step S102 of the subroutine shown in FIG. 7. First, the main CPU 41 judges whether a coin has been bet or not (step S201). Specifically, the main CPU 41 judges whether or not an input signal has been received. The input signal is output from the 1-BET switch 26S at the time of operation of the 1-BET button 26 or output from the MAX-BET switch 27S at the time of operation of the MAX-BET button 27. The main CPU 41 controls the current step to return to the process at step S201 upon judging that no coin has been bet (step S201: NO).

Next, the main CPU 41 subtracts the number of bet coins from the credit amount stored in the RAM 43 (step S202) upon judging that a coin has been bet (step S201: YES). Where the number of bet coins is larger than the credit amount stored in the RAM 43, the main CPU 41 controls the current step to return to step S201 without performing the process for subtracting the number of bet coins from the credit number stored in the RAM 43. Where the number of bet coins exceeds the upper limit (50 coins in this embodiment) of coins that can be bet in one game, the main CPU 41 controls the step to return to step 203 without performing the process for subtracting the number of bet coins from the credit number stored in the RAM 43.

The main CPU 41 judges whether or not the start button 23 has been set to ON (step S203). Specifically, the main CPU 41 judges whether or not an input signal output from the start switch 23S at the time of pushing of the start button 23 has been received. The main CPU 41 controls the step to return to step 201 upon judging that the start button 23 has not been set to ON (step S203: NO). Where the start button 23 has not been set to ON (for example, where an instruction has been input to terminate the game without setting the start button 23 to ON), the main CPU 41 cancels acceptance of a subtraction result at step S202.

On the other hand, the main CPU 41 performs a symbol rearrangement process (step S204) upon judging that the start button 23 has been set to ON (step S203: YES). Specifically, the CPU 41 executes the program stored in the RAM 43 and determines the symbols to be rearranged in the symbol matrix. The symbols are selected from among the symbols, “main character 121”, “sub character 122”, “office building 123”, “gold bullion 124”, “car 125”, “stock certificate 126”, “jet 127”, “villa 128”, “CHANCE 70a”, and “blank”. This determination is based on the symbol weighting data and random numeric values sampled by sampling the random numeric values in a numerical range which comes under a predetermined range of random numeric values. The CPU 41 then rearranges the symbols in the symbol matrix.

Next, the main CPU 41 judges whether a prize has been established or not (step S205). Specifically, the main CPU 41 judges whether or not a combination of symbols rearranged in the symbol matrix 28 results in a winning combination allowed to award any of payouts. Herein, the prize is established on condition that the three or more symbols of the same type are rearranged in the symbol matrix 28.

Next, upon judging that the prize is established (step S205: YES), the main CPU 41 performs a predetermined coin-payout process (step S206). In the coin-payout process, the main CPU 41 transmits the control signal to the hopper 66 to pay out the predetermined amount of coins. The CPU 41 may control the process to add the credit corresponding to the coins to be paid out to the credit amount stored in the RAM 43.

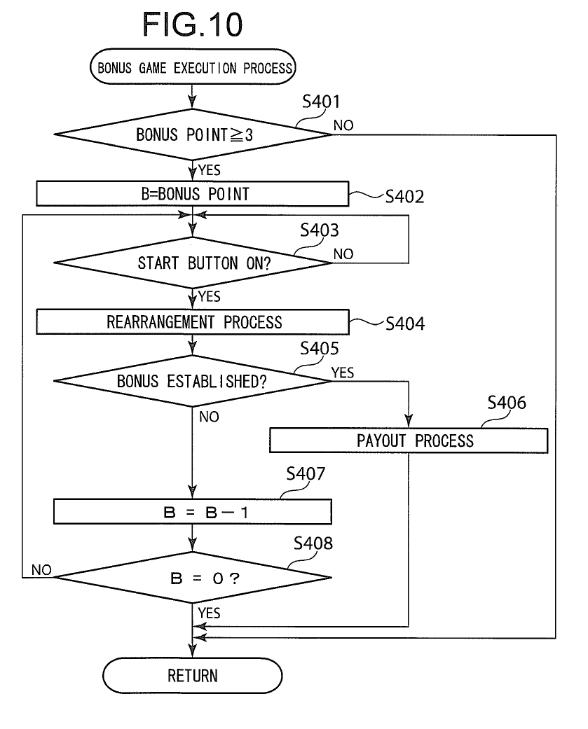

Next, the CPU 41 judges whether a free game trigger condition has been met or not (step S207) when judging that the prize is not established (step S205: NO) or after executing the payout process at step S206. Specifically, the main CPU 41 executes the program stored in the RAM 43 to sample the random numeric values in a numerical range which comes under a predetermined range of random numeric values, thereby judging whether or not the symbol “main character 121” is rearranged based on the sampled random numeric values. The main CPU 41 then counts the number of the rearranged symbols “main character 121” and judges that the free game trigger condition is met when the three or more symbols “main character 121” are rearranged. The main CPU 41 performs the free game execution process (step S208) when judging that the free game trigger condition is met (step S207: YES). In this free game execution process, the main CPU 41 reads and executes game programs or the like out of the RAM 43 in sequence, thereby executing the free game execution process. The main CPU 41 then executes the bonus game execution process, which will be explained later with reference to FIG. 10 (step S209). On the other hand, the main CPU 41 terminates the game execution process when judging that the free game trigger condition is not met at step S207 (step S207: NO) or when executing the process at step S209.

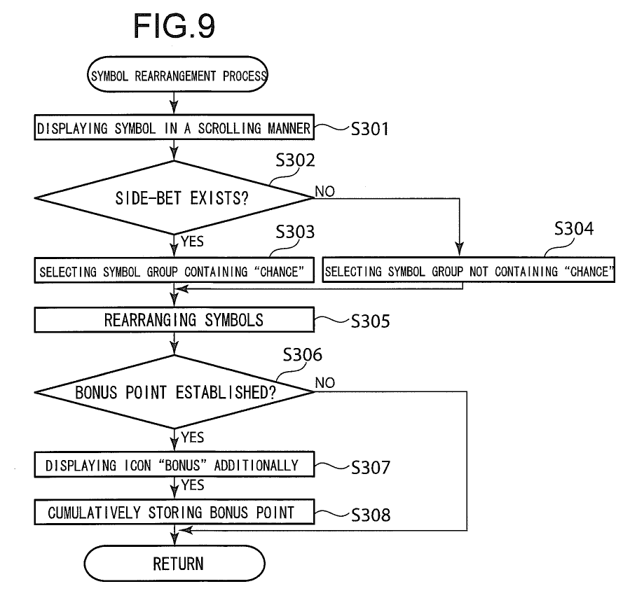

FIG. 9 is a flowchart showing a subroutine of a symbol rearrangement process which is invoked and executed at step S204 of the subroutine shown in FIG. 8. First, the main CPU 41 displays the symbols in a scrolling manner (step S301). Specifically, the main CPU 41 executes the program stored in the RAM 43 to perform a virtual display of an effect image that is virtually recognized as if the symbols are scrolled at high speed in a downward direction of a column of the symbol matrix.

The main CPU 41 then judges whether or not the side-BET button 85 has been set to ON (step S302). Specifically, the main CPU 41 judges whether or not the input signal has been received, the signal being output from the side-BET switch 90S when the side-BET button 85 is pressed. Upon judging that the side-BET button 85 has been set to ON (step S302: YES), the main CPU41 executes a process at step S303. Upon judging that the side-BET button 85 has not been set to ON (step S302: NO), the main CPU 41 executes a process at step S304.

The main CPU 41 selects a group of symbols containing the symbol “CHANCE 70a” from among a plurality of groups of symbols stored in the RAM 43. On the other hand, the CPU 41 selects the group of symbols not containing the symbol “CHANCE 70a” from among the plurality of groups of symbols stored in the RAM 43. In this manner, control is performed to rearrange the symbol “CHANCE 70a” in the symbol matrix 28 only when the side-BET has been placed.

The main CPU 41 then rearranges the symbols selected at step S304 or S305, in the symbol matrix (step S305). Specifically, the main CPU 41 executes the program stored in the RAM 43 to compare a numeric value determined based on each symbol weighting data to a random numeric value generated correspondingly to each cell of the symbol matrix 28, thereby determining the symbol to be arranged in each cell of the symbol matrix, from among the group of symbols selected at step S303 or S304. The main CPU 41 then rearranges the determined symbols.

Next, the main CPU 41 makes a judgment as to whether or not the symbol “CHANCE 70a” is contained in the symbols rearranged in the symbol matrix at step S305. In a case where the symbol “CHANCE 70a” is not included, the main CPU 41 terminates the symbol rearrangement process (step S306: NO). Where the symbol “CHANCE 70a” is included in the symbols rearranged in the symbol matrix 28, the main CPU 41 counts the number of symbols “CHANCE 70a”. Upon judging that three or more symbols “CHANCE” are contained (step S306: YES), the main CPU 41 causes the effect image display section 94 to display an effect image that one more icon “BONUS” is added (step S307).

The main CPU 41 then invokes a cumulative value of bonus points stored in the RAM 43, the value being equal to the number of icons “BONUS 70d” having been displayed by the time of the previous symbol rearrangement process. The main CPU 41 adds one to the value and then stores it again in the RAM 43 (step S308). The main CPU 41 terminates the symbol rearrangement process throughout the above described process.

FIG. 10 is a flowchart showing a subroutine of the bonus game execution process invoked and executed at step S209 of the subroutine shown in FIG. 8. First, the main CPU 41 invokes the cumulative number of bonus points stored in the RAM 43 and judges whether or not a right to execute the bonus game exists (step S401). Specifically, in the case of the cumulative number being equal to zero, the subroutine is terminated (step S401: YES). On the other hand, when the cumulative value is not equal to zero (step S401: NO), the number of bonus games is set (step S402). Specifically, the main CPU 41 sets a value of the bonus game number B to the bonus points, thereby storing the value in the RAM 43.

The main CPU 41 then judges whether or not the start button 23 has been set to ON (step S403). As described above, specifically, the main CPU 41 judges whether or not the input signal has been received, the signal being output from the start switch 23S when the start button 23 is pressed. Upon judging that the start button 23 has not been set to ON (step S403: NO), the main CPU 41 controls the step to return to steps subsequent to step S402. In a case where the start button 23 has not been set to ON (for example, where an instruction has been entered to terminate the game without setting the start button 23 to ON), the main CPU 41 displays alarm on the upper image display panel 33 and then sets the cumulative value of the bonus points to zero, thereby terminating the subroutine.

On the other hand, upon judging that the start button 23 has been set to ON (step S403: YES), the main CPU 41 performs the symbol rearrangement process (step S404). Specifically, the CPU 41 executes a program stored in the RAM 43 and samples a plurality of random numeric values corresponding to the symbol matrix 28 from among predetermined random numbers. The CPU 41 then compares the sampled random numeric values to symbol weighting data which comes under a predetermined numerical range. The CPU 41 determines the symbol to be rearranged in the symbol matrix from among the symbols, “main character 121”, “sub character 122”, “office building 123”, “gold bullion 124”, “car 125”, “stock certificate 126”, “jet 127”, “villa 128”, “CHANCE 70a”, and “blank”.

Next, the main CPU 41 judges whether the bonus has been established (step S405). Specifically, the main CPU 41 judges whether three or more symbols “sub character 122” serving as a bonus symbol, are rearranged in the symbol matrix 28 (see FIG. 7B).

Upon judging that the bonus has been established (step S405: YES), the main CPU 41 performs the payout process of coins (step S406), the number of which is determined based on the cumulative number of credits having been cumulatively stored in the memory region set in the RAM 43. In a case where the coins are deposited, the main CPU 41 performs a process of adding the number of paid-out coins to the credit amount stored in the RAM 43. In a case where the coins are paid out, the main CPU 41 pays out the predetermined number of coins by transmitting the control signal to the hopper 66.

On the other hand, upon judging that the bonus has not been established (step S405: NO), the main CPU 41 sets the remaining bonus game number to B=B−1 (step S407). Specifically, the main CPU 41 sets B=B−1 at a value of the remaining bonus game number B stored in the RAM 43.

Next, the main CPU 41 judges whether or not a value of the remaining free game number B is equal to zero (step S408). Specifically, the main CPU 41 judges whether or not the remaining game number B stored in the RAM 43 is equal to zero. Upon judging that a value of B is not equal to zero (step S408: NO), the main CPU 41 controls the step to shift to step S403. Upon judging that a value of B is equal to zero (step S408: YES), on the other hands, the main CPU 41 clears a cumulative value of bonus points stored in the RAM 43 and terminates the subroutine.

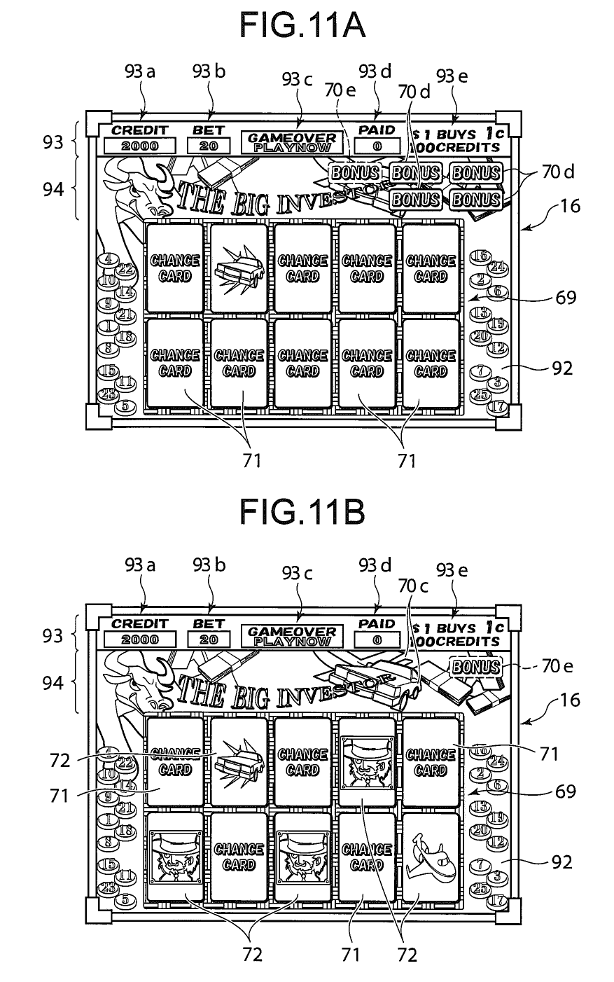

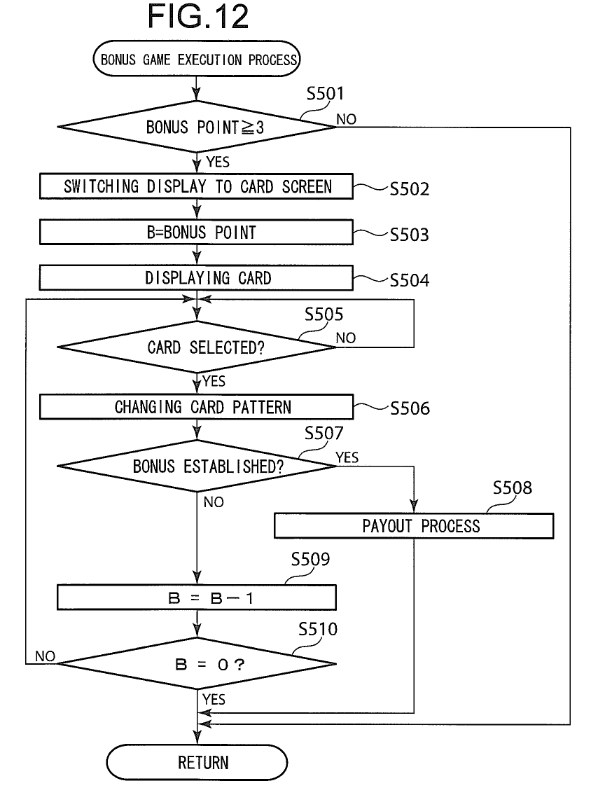

FIGS. 11A, 11B, and 12 are views each showing a case in this embodiment where the bonus game is executed not as the above-described symbol rearrangement game but as a card game. FIGS. 11A and 11B are views each showing an exemplary image displayed on the lower image display panel 16. FIG. 12 is an execution flowchart of the card game as a bonus game.

FIGS. 11A and 11B are views each showing an exemplary image displayed on the lower image display panel 16 during the bonus game. Upon start of the bonus game, the display region 92 of the lower image display panel 16 switches a screen to a card display screen in which ten cards are displayed in a face-down manner. In this case, the display region 92 functions as a touch panel, and the CPU 41 judges the card touched by the player as the selected one. The player can designate cards as many as the number of icons “BONUS” displayed on the display region 94, that is, the number of bonus points. In the case shown in FIG. 11A, the player designates one card and the CPU 41 changes a pattern to the symbol “car 125”. On the other hand, the icon “BONUS 70e” displayed on the display region 94 disappears after blinking. The player can designate the cards as many as the remaining number, four in this case, of icons “BONUS”.

FIG. 11B shows an exemplary display of the lower image display panel 16 when the player designates cards in succession. FIG. 11B shows a state that the player designates the fifth card after designating four cards, and the CPU 41 changes a pattern of the fifth card to the bonus symbol “sub character 122”. In FIG. 11B, the three symbols “sub character 122” are displayed, which meets the condition for establishment of the bonus, so that the jackpot is awarded.

FIG. 12 is a flowchart of the bonus game execution process invoked and executed at step S209 of the subroutine shown in FIG. 8. In this case, the bonus game is a card game having been explained with reference to FIG. 11. First, the main CPU 41 invokes a cumulative value of bonus points stored in the RAM 43 and judges whether or not a right to execute the bonus game exists (step S501). Specifically, in a case of two or less bonus points, the subroutine is terminated (step S501: NO). On the other hand, in a case of three or more bonus points (step S501: YES), the main CPU 41 switches display of the display region 92 from the symbol matrix 28 to the card display (step S502). At this time, the symbol matrix 28 disappears but the card is not yet displayed. Next, the CPU 41 sets the number of cards which can be selected (step S503). Specifically, the main CPU 41 sets B=bonus points at a value of the selectable card number B and stores the value in the RAM 43. Thereafter, the more cards than the number of bonus points are displayed on the display region 92 (step S404).

Next, the main CPU 41 judges whether or not the player selects the card by touching the display region 92 functioning as a touch panel (step S505). Upon judging that the selection has not been made (step S505: NO), the main CPU 41 displays a selection command on the upper image display panel 33 and stands by until when the card is selected. In a case where the card has not been selected (for example, where an instruction has been input to terminate the game), the main CPU 41 displays an alarm on the upper image display panel 33, sets a cumulative value of bonus points to zero, and terminates the subroutine.

On the other hand, upon judging that the card has been selected (step S505: YES), the main CPU 41 changes a pattern of the selected card to display the symbol (step S506). Specifically, the CPU 41 executes the program stored in the RAM 43 and samples a plurality of random numeric values corresponding to the card from among predetermined random numbers. The CPU 41 then compares the sampled random numeric values to symbol weighting data which comes under a predetermined numerical range. The CPU 41 determines the symbol to be rearranged in the symbol matrix from among the symbols, “main character 121”, “sub character 122”, “office building 123”, “gold bullion 124”, “car 125”, “stock certificate 126”, “jet 127”, and “villa 128”.

Next, the main CPU 41 judges whether or not the bonus has been established (step S507). Specifically, the main CPU 41 judges whether or not three or more cards are displayed, the cards displaying thereon the bonus symbol “sub character 122” (see FIG. 11B).

Upon judging that the bonus has been established (step S507: YES), the main CPU 41 then performs the payout process of coins (step S508), the number of which is determined based on the cumulative number of credits having been cumulatively stored in the memory region set in the RAM 43 (step S508). In a case where the coins are deposited, the main CPU 41 performs a process for adding the number of paid-out coins to the credit amount stored in the RAM 43. In a case where the coins are paid out, the main CPU 41 pays out the predetermined number of coins by transmitting the control signal to the hopper 66.

On the other hand, upon judging that the bonus has not been established (step S507: NO), the main CPU 41 sets the remaining number of selectable cards B=B−1 (step S509). Next, the main CPU 41 judges whether or not a value of B is equal to zero (step S510). In a case of judging that a value of B is not equal to zero (step S510: NO), the main CPU 41 controls the step to return to step S505 and stands by for the next selection of the card. On the other hand, upon judging that a value of B is equal to zero (step S410: YES), the main CPU 41 clears a cumulative value of bonus points stored in the RAM 43 and terminates the subroutine.

Next, a slot machine 100 according to a second embodiment will be described with reference to the drawings. The slot machine according to the second embodiment below is a so-called hybrid slot machine in which a plurality of rotatably-supported mechanical reels have a transparent liquid crystal panel on front surfaces to display images of various symbols drawn on peripheral surfaces of the mechanism reels through the transparent liquid crystal panel through which the pictures are allowed to pass. The slot machine according to the second embodiment has an appearance, circuitry, and the like that are substantially the same as those of the slot machine 10 according to the first embodiment. Thus, a duplicated explanation is omitted here. Constituent elements corresponding to those of the slot machine 10 are designated by the same reference numerals and are explained.

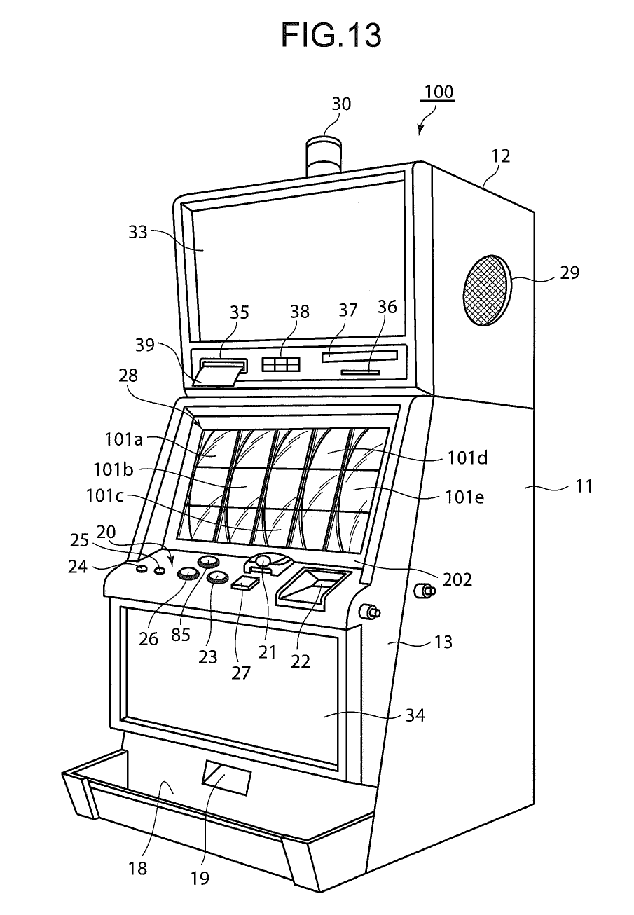

FIG. 13 is a view schematically showing an appearance of the slot machine according to the second embodiment. As shown in FIG. 13, the slot machine 100 is rotatably provided with five reels 101a to 101e. A symbol column made up of the symbols “blank”, “main character 121”, “sub character 122”, “office building 123”, “gold bullion 124”, “car 125”, “stock certificate 126”, “jet 127”, and “villa 128” is drawn on the respective one of the outer circumferential surfaces of the reels 101a to 101e,.

A main liquid crystal panel 202 formed of a transparent liquid crystal panel, which is disposed at the main door, is provided in front of the respective reels 101a to 101e. The main liquid crystal panel 202 displays the symbol display region 28 with visually recognizable rear surface so as to surround symbols displayed in the reels 101a to 101e in a stopped state, respectively. The symbols drawn on the reels 101a to 101e are visualized by rendering the symbol display region transparent.

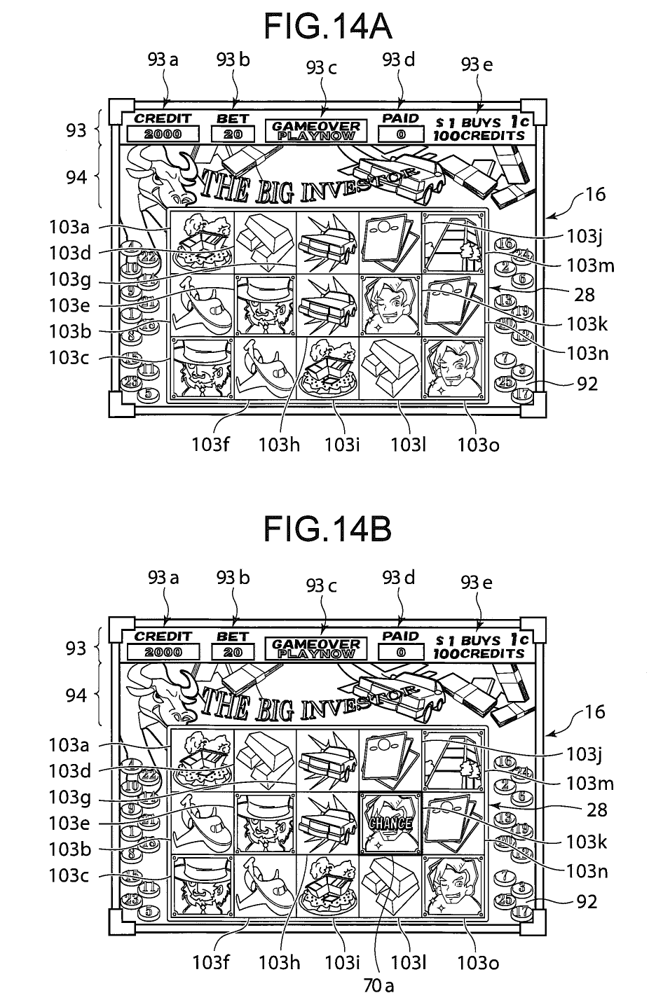

FIGS. 14A and 14B are views each showing an exemplary display of the lower image display panel 16 during the basic game executed in the slot machine 100. In FIG. 14A, the five reels 101a to 101e are displayed in a stopped state, and respective frames 103a to 103o of the symbol display region in the main liquid crystal panel 202 are transparently displayed so as to render these five reels 101a to 101e visually recognizable. In this case, the symbols “main character 121”, “sub character 122”, “office building 123”, “gold bullion 124”, “car 125”, “stock certificate 126”, “jet 127”, and “villa 128” are displayed in a stopped state.

During the process with the slot machine 100 corresponding to the rearrangement process of the basic game (see FIG. 9) according to the first embodiment, the symbol “CHANCE 70a” to be rearranged is rearranged on the frame of the symbol matrix 28 of the liquid panel 202. The symbol drawn on the reel is fixed, so that control whether to rearrange the symbol “CHANCE 70a”, which is decided based on existence of the side BET, cannot be performed. On the liquid crystal panel, on the other hand, this control can be easily performed by selecting display or non-display. FIG. 14B shows a state where the symbol “CHANCE 70a” is rearranged on the symbol matrix 28 of the liquid crystal panel 202 as compared with display in a stopped state of the five reels 101a to 101e shown in FIG. 14A. In a frame 103k of the symbol matrix 28, the symbol “CHANCE 70a” is displayed in superposition with the symbol “main character 121” so that both of the symbols “CHANCE 70a” and “main character 121” can be visually recognizable.

As described above, the slot machine 100 according to the second embodiment exercises control over the game so as to award the bonus point during the basic game according to the first embodiment. On the other hand, the card game executed in the bonus game (see FIGS. 11 and 12) is carried out on the display region 92 of the liquid crystal panel 202.

In the foregoing, while the embodiments of the present invention have been described, these embodiments merely present specific examples. An appropriate design change can be made for the specific configuration of each means or the like. Also, the effects described in the embodiments of the present invention are only listing the most preferable effects arising from the present invention, and the effects of the present invention are not limited to those described in the embodiments of the present invention.

What is claimed is:

1. A slot machine, comprising:
a display device having a symbol display region for displaying plural types of symbols in a matrix form;
an input device for accepting BET;
a first memory for cumulatively storing a bonus point which is awarded, in a case where a predetermined number or more of first symbols contained in the plural types of symbols are rearranged in the symbol display region;
a second memory for cumulatively storing at least one part of a credit which is bet through the input device; and
a controller for controlling the display device, the input device, the first memory, and the second memory, the controller being programmed to:
(a) execute a basic game;
(b) rearrange the plural types of symbols in the symbol display region during the basic game;
(c) add the bonus point to a cumulative value of the first memory during the basic game;
(d) add the credit to a cumulative value of the second memory during the basic game;
(e) execute a free game, in a case where a predetermined condition is met during the basic game;
(f) execute a bonus game by a number of times equal to the cumulative value of the bonus points stored in the first memory, during a predetermined period from before start to after termination of the free game; and
(g) award a prize determined based on the cumulative value of the second memory, in a case where a second symbol displayed in the symbol display region met a predetermined condition during the bonus game.

2. The slot machine according to claim 1, wherein:
the controller, in the itemized (g), determines plural types of prizes based on the cumulative value of the second memory and, awards the prize according to an outcome of the bonus game.

3. The slot machine according to claim 1, wherein:
the controller, in the itemized (f), executes the bonus game that the plural types of symbols containing the second symbol are rearranged.

4. The slot machine according to claim 3, wherein:
the controller, in the itemized (f), terminates the bonus game without execution of remaining bonus games during the plural bonus games, in a case where the second symbol is rearranged before a last bonus game.

5. The slot machine according to claim 1, wherein:
the controller, in the itemized (f), rearranges a plurality of cards on which the symbols containing the second symbol are drawn, in the symbol display region in a state where the symbols are invisible, and executes the bonus game that the equal number of cards to the cumulative value of the second memory are switched in a state where the symbols are visible.

6. The slot machine according to claim 1, further comprising an input device for accepting entry of side BET, wherein:
the controller, in the itemized (b), rearranges the first symbol in the symbol display region upon accepting the entry of the side BET from the input device.

7. A slot machine, comprising:
a display device having a symbol display region for displaying plural types of symbols in a matrix form;
an input device for accepting BET;
a first memory for cumulatively storing a bonus point which is awarded, in a case where a predetermined number or more of first symbols contained in the plural types of symbols are rearranged in the symbol display region;
a second memory for cumulatively storing at least one part of a credit which is bet through the input device; and
a controller for controlling the display device, the input device, the first memory, and the second memory, the controller being programmed to:
(a) execute a basic game;
(b) rearrange the plural types of symbols in the symbol display region during the basic game;
(c) add the bonus point to a cumulative value of the first memory during the basic game;
(d) add the credit to a cumulative value of the second memory during the basic game;
(e) execute a free game, in a case where a predetermined condition is met during the basic game;
(f) execute a bonus game by a number of times equal to the cumulative value of the bonus points stored in the first memory, during a predetermined period from before start to after termination of the free game; and
(g) determines plural types of prizes based on the cumulative value of the second memory and,
awards the prize according to an outcome of the bonus game, in a case where a second symbol displayed in the symbol display region met a predetermined condition during the bonus game.

8. The slot machine according to claim 7, wherein:
the controller, in the itemized (f), executes the bonus game that the plural types of symbols containing the second symbol are rearranged.

9. The slot machine according to claim 8, wherein:
the controller, in the itemized (f), terminates the bonus game without execution of remaining bonus games during the plural bonus games, in a case where the second symbol is rearranged before a last bonus game.

10. The slot machine according to claim 7, wherein:
the controller, in the itemized (f), rearranges a plurality of cards on which the symbols containing the second symbol are drawn, in the symbol display region in a state where the symbols are invisible, and executes the bonus game that the equal number of cards to the cumulative value of the second memory are switched in a state where the symbols are visible.

11. The slot machine according to claim 7, further comprising an input device for accepting entry of side BET, wherein:
the controller, in the itemized (b), rearranges the first symbol in the symbol display region upon accepting the entry of the side BET from the input device.

12. A slot machine, comprising:
a display device having a symbol display region for displaying plural types of symbols in a matrix form;
an input device for accepting BET;
a first memory for cumulatively storing a bonus point which is awarded, in a case where a predetermined number or more of first symbols contained in the plural types of symbols are rearranged in the symbol display region;
a second memory for cumulatively storing at least one part of a credit which is bet through the input device; and
a controller for controlling the display device, the first memory, and the second memory, the input device,
the input device further accepting entry of side BET, the controller being programmed to:
(a) execute a basic game;
(b) rearrange the plural types of symbols in the symbol display region during the basic game;
(c) rearrange the first symbol in the symbol display region upon accepting the entry of the side BET from the input device;
(d) add the bonus point to a cumulative value of the first memory during the basic game;
(e) add the credit to a cumulative value of the second memory during the basic game;
(f) execute a free game, in a case where a predetermined condition is met during the basic game;
(g) execute a bonus game by a number of times equal to the cumulative value of the bonus points stored in the first memory, during a predetermined period from before start to after termination of the free game; and
(h) determine plural types of prizes based on the cumulative value of the second memory and,
awards the prize according to an outcome of the bonus game, in a case where a second symbol displayed in the symbol display region met a predetermined condition, during the bonus game.

13. The slot machine according to claim 12, wherein:
the controller, in the itemized (g), executes the bonus game that the plural types of symbols containing the second symbol are rearranged.

14. The slot machine according to claim 13, wherein:
the controller, in the itemized (g), terminates the bonus game without execution of remaining bonus games during the plural bonus games, in a case where the second symbol is rearranged before a last bonus game.

15. The slot machine according to claim 12, wherein:
the controller, in the itemized (g), rearranges a plurality of cards on which the symbols containing the second symbol are drawn, in the symbol display region in a state where the symbols are invisible, and executes the bonus game that the equal number of cards to the cumulative value of the second memory are switched in a state where the symbols are visible.
